(19) United States
(12) Patent Application Publication
(10) Pub. No.: US 2006/0241787 A1
(43) Pub. Date: Oct. 26, 2006

(54) Controlled system model generating method and apparatus

(76) Inventors: Masato Tanaka, Tokyo (JP); Mayumi Miura, Tokyo (JP); Seiji Kato, Tokyo (JP)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/408,230

(22) Filed: Apr. 19, 2006

(30) Foreign Application Priority Data
Apr. 22, 2005 (JP) 124783/2005

(51) Int. Cl. G05B 13/02

(52) U.S. Cl. 700/30; 700/29; 700/31; 700/28

(57) ABSTRACT

A controlled system model generating apparatus includes a real controlled variable storage unit which stores time-series data of a real controlled variable, a model storage unit which stores a mathematical model of a controlled system, a controller storage unit which stores a controller algorithm, a simulation computation unit which executes a simulation of simulating a control response concerning a control system, an evaluation function computation unit which compares a real controlled variable with a model controlled variable and computes an evaluation function value representing a proximity between the real controlled variable and the model controlled variable, and a controlled system model parameter search computation unit which causes the simulation computation unit to execute a simulation while sequentially changing a value of a controlled system model parameter set for a mathematical model, and determines a value of a controlled system model parameter with which an evaluation function value becomes an optimal value. A controlled system model generating method is also disclosed.

### BACKGROUND OF THE INVENTION

The present invention relates to a controlled system model generating method and apparatus for generating a controlled system model.

When control parameters for a controller are to be adjusted, there is available a method of determining optimal control parameters by repeating a series of processes of manually adjusting a control parameter on the basis of operator's experience and knowledge, actually controlling a controlled system by using a controller for which the parameter has been set, detecting the controlled variable output from the controlled system in accordance with the manipulated variable output from the controller, and comparing the controlled variable with a set point.

This method requires enormous labor and adjustment cost. In place of this method, therefore, there is executed a process of analyzing process parameters (e.g., a process gain and a process time constant) including degrees for a controlled system and determining control parameters. In this process, a modeling step of approximating a characteristic of the controlled system by a mathematical model is executed, and control parameters are determined by referring to the modeling result. Conventionally, however, this method requires specialized speculation and operation, and hence anyone cannot always use the method.

In consideration of such situations, a control parameter adjustment technique has been proposed in reference 1 (Japanese Patent Laid-Open No. 2004-38428), in which a mathematical model of a controlled system is automatically generated by acquiring the time-series data of the manipulated variables output from a controller to the controlled system and the time-series data of the controlled variables output from the controlled system in accordance with the manipulated variables, and the operator can easily adjust control parameters for the controller while checking control characteristics when the control parameters are changed in a simulation using the mathematical model.

The control parameter adjustment technique described in reference 1 allows even a user who is not familiar with the modeling of a controlled system to generate a mathematical model of the controlled system and easily adjust control parameters for a controller using the model. In automatic generation of a mathematical model, a data acquisition device is required, which acquires the time-series data of a manipulated variable MV output to a controlled system and the time-series data of a controlled variable PV output from the controlled system accordingly in the same data acquisition period in advance, and stores the acquired data in an electronic medium.

In general, although the controlled variable PV of the controlled system is displayed or monitored during the operation of the control system, a manipulated variable is rarely displayed or monitored. For this reason, in many cases, the time-series data of the manipulated variable MV cannot be acquired due to limitations on hardware or the like as well. In this case, although the time-series data of the controlled variable PV can be acquired, the time-series data of the manipulated variable MV cannot be acquired. As a result, since both the time-series data of the controlled variable PV and that of manipulated variable MV cannot be acquired, a mathematical model cannot be generated. It therefore often happens that control simulation or parameter adjustment cannot be performed.

### SUMMARY OF THE INVENTION

The present invention has been made to solve the above problem, and has as its object to allow generation of a mathematical model of a controlled system from only the time-series data of a controlled variable without using the time-series data of a manipulated variable which is required in the prior art when a mathematical model of a controlled system is to be automatically generated.

It is another object of the present invention to generate a mathematical model of a controlled system without any expert knowledge about control and modeling.

According to the present invention, there is provided a controlled system model generating apparatus comprising a real controlled variable storage unit which stores time-series data of a real controlled variable as a control result on an actual controlled system, a model storage unit which stores, in advance, a mathematical model of a controlled system having at least one parameter, a controller storage unit which stores, in advance, a controller algorithm which virtually generates a controller, a simulation computation unit which executes a simulation of simulating a control response concerning a control system comprising the controlled system represented by a mathematical model stored in the model storage unit and a controller represented by the controller algorithm stored in the controller storage unit, an evaluation function computation unit which compares a real controlled variable stored in the real controlled variable storage unit with a model controlled variable which is a controlled variable calculated by a simulation executed by the simulation computation unit and computes an evaluation function value representing a proximity between the real controlled variable and the model controlled variable, and a controlled system model parameter search computation unit which causes the simulation computation unit to execute a simulation while sequentially changing a value of a controlled system model parameter set for the mathematical model, and determines, as a model parameter search result, a value of a controlled system model parameter with which an evaluation function value computed by the evaluation function computation unit becomes an optimal value.

According to the present invention, there is provided a controlled system model generating method comprising the steps of executing a simulation of simulating a control response concerning a control system comprising a controlled system represented by a mathematical model stored in advance and a controller represented by a controller algorithm stored in advance, comparing a real controlled variable as a control result on an actual real controlled system and a model controlled variable as a controlled variable calculated by a simulation, and computing an evaluation function value representing a proximity between the real controlled variable and the model controlled variable, and executing a simulation while sequentially changing a value of a controlled system model parameter set for the mathematical model, and determining, as a model parameter search result, a value of a controlled system model parameter with which an evaluation function value becomes an optimal value.

### BRIEF DESCRIPTION OF THE DRAWINGS

FIG. 1 is a block diagram showing the arrangement of a controlled system model generating apparatus according to an embodiment of the present invention;

FIG. 2 is a flowchart showing the operation of the controlled system model generating apparatus shown in FIG. 1;

FIG. 3 is a block diagram of a virtual control system in the embodiment of the present invention; and

FIG. 4 is a flowchart showing the operation of a simulation computation unit in FIG. 1.

### DESCRIPTION OF THE PREFERRED EMBODIMENT

In the present invention, a control system model obtained by a combining a controller algorithm used by a user in an actual control system and a mathematical model of a controlled system is virtually generated on a computer, and a model controlled variable of the control system is calculated from a control result obtained by giving set parameters for a controller actually used by the user to the control system model. A simulation of the control system model is repeated by using an evaluation function representing the proximity between the time-series data of an actually observed actual controlled variable and the time-series data of a model controlled variable such that the evaluation function value reaches an optimal value. In this manner, a search is made for one parameter or a numerical combination of a plurality of parameters in the mathematical model of the controlled system. Set parameters for the controller include setting items, e.g., control parameters (e.g., a proportional band, integral time, and derivative time in the case of a PID controller) and the upper and lower limit values of manipulated variables.

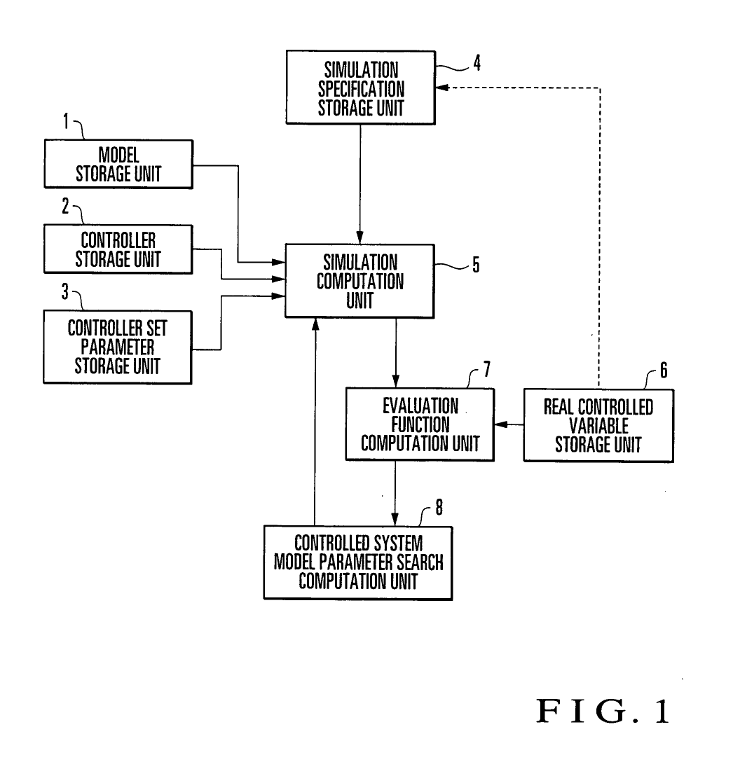

An embodiment of the present invention will be described in detail below with reference to the accompanying drawings. As shown in FIG. 1, a controlled system model generating apparatus according to this embodiment comprises a model storage unit 1 which stores, in advance, a mathematical model of a controlled system, a controller storage unit 2 which stores, in advance, a controller algorithm for virtually generating a controller, a controller set parameter storage unit 3 which stores, in advance, set parameters for the controller, a simulation specification storage unit 4 which stores, in advance, specifications for a simulation, a simulation computation unit 5 which executes a simulation of simulating a control response concerning a control system comprising a controlled system represented by a mathematical model and a controller represented by a controller algorithm, a real controlled variable storage unit 6 which stores the time-series data of a real controlled variable as a control result on an actual controlled system, an evaluation function computation unit 7 which computes an evaluation function value representing the proximity between a real controlled variable and a model controlled variable by comparing the real controlled variable with the model controlled variable which is a controlled variable calculated by a simulation, and a controlled system model parameter search computation unit 8 which causes the simulation computation unit 5 to execute a simulation while sequentially changing the value of a controlled system model parameter set in a mathematical model, and determines, as a model parameter search result, the value of a controlled system model parameter with which an evaluation function value becomes an optimal value.

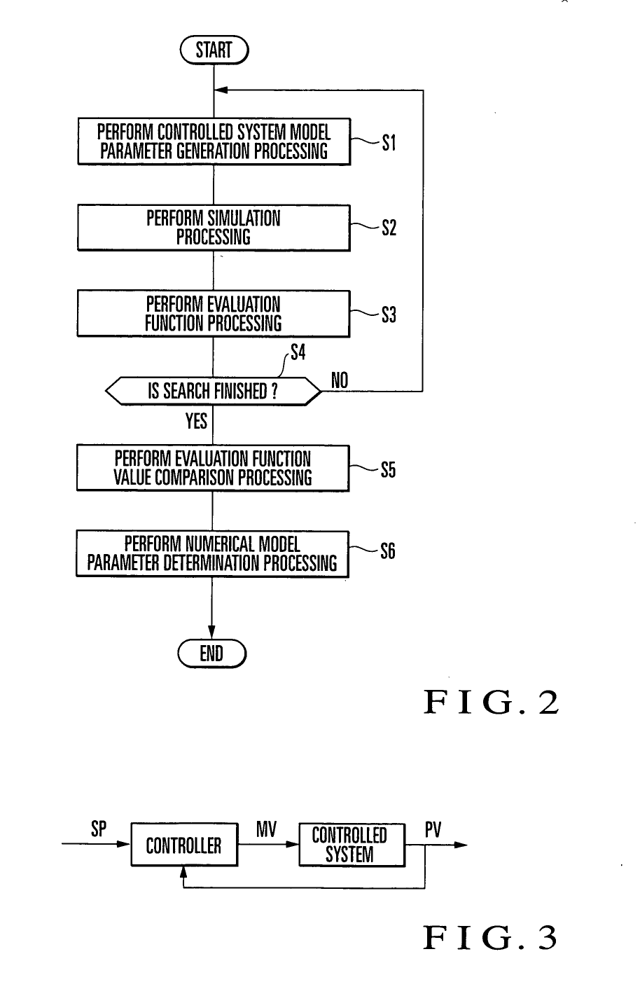

The operation of the controlled system model generating apparatus according to this embodiment will be described below. The operation of each constituent element will be described first. The flow of overall processing will be described next with reference to FIG. 2. Note that the following description will exemplify a case wherein temperature control is directed to raise a temperature.

A combination (t[i], realPV[i]) of the time-series data of a controlled variable realPV[i] as a control result on an actual controlled system and the time-series data of time (an elapsed time from the start time of control) t[i] when the controlled variable realPV[i] is acquired is registered in the real controlled variable storage unit 6 in advance. The controlled variable realPV[i] is obtained from the result obtained by control executed on an actual controlled system using an actual PID controller for which the same values as the PID parameters in the controller set parameter storage unit 3 are set.

A mathematical model of a controlled system having one or a plurality of parameters is registered in the model storage unit 1 by a user who uses the controlled system model generating apparatus. At this time, each parameter is registered as a variable. If, for example, a controlled system has elements of a first-order lag and a dead time, and a transfer function Gp for the controlled system is expressed by transfer function equation (1), transfer function expression (1) is registered as a mathematical model of the controlled system. At this time, a process gain Kp, process dead time Lp, and process time constant T1 are registered as variables. In equation (1), s represents a Laplace operator.
Gp=Kpexp(−Lps)/(1+T1s) (1)

A control algorithm, i.e., a program for causing the simulation computation unit 5 to virtually generate a controller equivalent to an actual apparatus used to control a controlled system, is registered in the controller storage unit 2 in advance by the user. For example, when the PID controller is to be used, the following transfer function equation representing a PID controller algorithm is registered in advance.
MV=(100/Pb){1+(1/Tis)+Tds}(SP−PV) (2)
where Pb, Ti, and Td are PID parameters, of which Pb is a proportional band, Ti is an integral time, and Td is a derivative time, MV is a manipulated variable, SP is a set point, and PV is a controlled variable. The proportional band Pb, integral time Ti, derivative time Td, and set point SP are registered in the controller set parameter storage unit 3 in advance. The manipulated variable MV and the controlled variable PV are variables which dynamically change at the time of a simulation performed by the simulation computation unit 5.

Parameters for the controller which are required to calculate the manipulated variable MV in accordance with the controller algorithm registered in the controller storage unit 2 are registered by the user in the controller set parameter storage unit 3 in advance. The registered parameters in the case of, for example, PID controller algorithm represented by equation (2) include the proportional band Pb, integral time Ti, and derivative time Td as PID parameters, and the set point SP and a controller control period cdt as other parameters. Note that after a controlled system model is generated by the controlled system model generating apparatus of this embodiment, the final values of PID parameters are obtained by a known technique using the controlled system model. Therefore, the appropriate values of PID parameters are undetermined at this time, and the values of PID parameters registered in the controller set parameter storage unit 3 are the values arbitrarily set by the user in the actual control system.

Initial values used for simulation computation, the type of parameter used to determine the end of a simulation, and the respective values are registered in the simulation specification storage unit 4 in advance by the user. The values to be registered include, for example, an initial value PVini of the controlled variable PV, an initial value MVini of the manipulated variable, and a total simulation time tsim. The total simulation time tsim is used to determine the end of a simulation. When an elapsed time from the start time of a simulation reaches tsim, the simulation ends. The total simulation time tsim and the controlled variable initial value PVini can be determined by referring to the time-series data stored in the real controlled variable storage unit 6. For example, the total simulation time tsim may be determined by the maximum value of the time t[i] stored in the real controlled variable storage unit 6. As the controlled variable initial value PVini, the initial value of the controlled variable realPV[i] may be used.

The simulation computation unit 5 performs a simulation of simulating a control response concerning a virtual control system comprising the controlled system represented by the mathematical model in the model storage unit 1 and the controller represented by the controller algorithm in the controller storage unit 2, on the basis of the controller set parameters registered in the controller set parameter storage unit 3, the simulation specifications registered in the simulation specification storage unit 4, and the controlled system model parameters generated by the controlled system model parameter search computation unit 8. FIG. 3 shows a virtual control system in this case. The simulation computation unit 5 obtains a combination (t[i], mdlPV[i]) of the time-series data of the time t[i] within the total simulation time and the time-series data of a controlled variable mdlPV[i] by repeatedly executing computation of a manipulated variable mdlMV[i] corresponding to a controlled variable mdlPV[i−1] at time t[i−1] and computation of the controlled variable mdlPV[i] using the manipulated variable mdlMV[i] and the mathematical model of the controlled system.

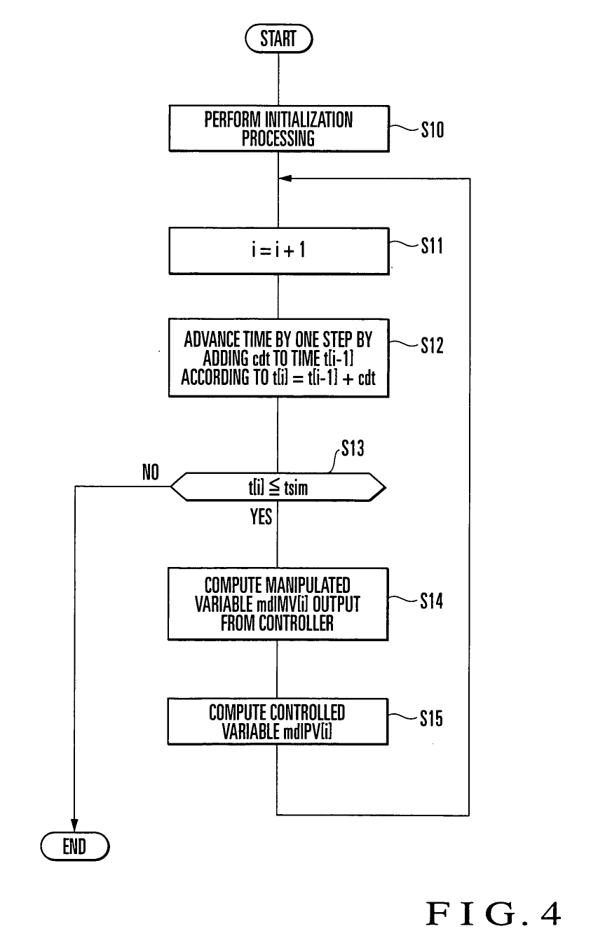

The operation of the simulation computation unit 5 will be described with reference to FIG. 4. The simulation computation unit 5 executes initialization processing (step S10 in FIG. 4), simulation processing (steps S11, S12, S14, and S15), and simulation end determination processing (step S13).

In initialization processing, the simulation computation unit 5 initializes a count value i for identifying simulation time t[i] to 0, and simulation start time t[0] to 0. In addition, the simulation computation unit 5 sets an initial value mdlPV[0] of a controlled variable at the simulation start time to PVini and an initial value mdlMV[0] of a manipulated variable to MVini on the basis of the simulation specifications registered in the simulation specification storage unit 4.

In simulation processing, the simulation computation unit 5 counts up the count value i to i=1 (step S11), and then calculates the simulation time t[i] according to t[i]=t[i−1]+cdt (step S12).

Subsequently, the simulation computation unit 5 performs simulation end determination processing on the basis of the total simulation time tsim registered in the simulation specification storage unit 4, and determines whether t[i]≦tsim holds (step S13). If the simulation computation unit 5 determines that t[i]≦tsim, i.e., the time t[i] has not exceeded the total simulation time tsim, the flow advances to step S14 to continue simulation processing.

When the simulation processing is to be continued, the simulation computation unit 5 calculates the manipulated variable mdlMV[i] at the time t[i] using the parameters registered in the controller set parameter storage unit 3 according to equation (2) registered in the controller storage unit 2.
mdlMV[i]=(100/Pb){1+(1/Tis)+Tds}(SP−mdlPV[i−1]) (3)

The simulation computation unit 5 calculates the controlled variable mdlPV[i] at the time t[i] using the controlled system model parameters generated by the controlled system model parameter search computation unit 8 according to equation (1) registered in the model storage unit 1 (step S15).
mdlPV[i]={Kpexp(−Lps)/(1+T1s)}mdlMV[i] (4)

The simulation computation unit 5 stores the calculated controlled variable mdlPV[i] in correspondence with the time t[i].

The flow then returns to step S11, in which the simulation computation unit 5 counts up the count value i by one to i=2, and performs processing of calculating (t[i], mdlPV[i]) in the same manner as in the case of i=1. In this manner, the processing in steps S11 to S15 is repeated. If it is determined in step S13 that t[i]>tsim, i.e., the time t[i] has exceeded the total simulation time tsim, during the repetitive processing, the simulation computation unit 5 terminates the simulation processing. At this end time, a combination (t[i], mdlPV[i]) of the time-series data of the time t[i] within time t[i]=0 to t[i]=tsim and the time-series data of the controlled variable mdlPV[i] will have been obtained.

The evaluation function computation unit 7 then executes evaluation function processing of comparing a real controlled variable realPV stored in the real controlled variable storage unit 6 with a model controlled variable mdlPV computed by the simulation computation unit 5, and obtaining an evaluation function value F representing the proximity between them. Assume that the real controlled variable acquisition period stored in the real controlled variable storage unit 6 is equal to the control period cdt stored in the controller set parameter storage unit 3. At this time, the real controlled variable realPV is equal to the number of model controlled variables mdlPV (the number of time steps), and a real controlled variable realPV[j] when the acquisition time (an elapsed time from the control start time 0) is t[j] corresponds to a model controlled variable mdlPV[j] when the simulation time (an elapsed time from the simulation start time 0) is t[j]. The evaluation function computation unit 7 obtains the evaluation function value F upon initializing the evaluation function value F to O.

$$F = {\sum }_{j = 0}^{j max} {( realPV [ j ] - mdlPV [ j ] )}^{2} \qquad ( 5 )$$

where j is an integer representing a time step of 0≦j≦max, and jmax is an integer which satisfies t[jmax]=tsim. In this example, the evaluation function value F which becomes the minimum value (positive value) near 0 is an optimal value. In this case, the real controlled variable becomes closest to the model controlled variable.

The controlled system model parameter search computation unit 8 includes a controlled system model parameter generating unit, evaluation function value comparing unit, and controlled system model parameter generating unit.

The controlled system model parameter generating unit sequentially generates all values which controlled system model parameters can take, i.e., all combinations of values which the process gain Kp, process dead time Lp, and process time constant T1 can take, one by one. Let dKp, dLp, and dT1 be change widths for the generation of the respective parameters in this case. Let Kp_max be a predetermined maximum value of the process gain, Lp_max be a predetermined maximum value of the process dead time, and T1_max be a predetermined maximum value of the process time constant. In this case, the process gain Kp is generated within the range of 0<Kp≦Kp_max with an accuracy of dKp, the process dead time Lp is generated within the range of 0≦Lp≦Lp_max with an accuracy of dLp, and the process time constant T1 is generated within the range of 0≦T1≦T1_max with an accuracy of dT1. The processing executed by the controlled system model parameter generating unit will be referred to as controlled system model parameter generation processing.

The evaluation function value comparing unit compares the evaluation function values F calculated with respect to all combinations of values which the process gain Kp, process dead time Lp, and process time constant T1 can take, and extracts a combination of the process gain Kp, process dead time Lp, and process time constant T1 which provides a minimum evaluation function value F_min (F_min≧0) of all the evaluation function values F. This processing will be referred to as evaluation function value comparison processing.

The controlled system model parameter determining unit uses the combination of the process gain Kp, process dead time Lp, and process time constant T1 which is extracted by the evaluation function value comparison processing as a model parameter search result. This processing will be referred to as controlled system model parameter determination processing.

Note that the processing performed by the controlled system model parameter search computation unit 8 described above is a technique of causing the simulation computation unit 5 to execute simulation processing while generating all the values which controlled system model parameters can take one by one, and searching for optimal controlled system model parameter values by comparing all the calculated evaluation function values F. This technique gives no consideration to search efficiency, and is merely an example. As an efficient technique of causing the simulation computation unit 5 to operate in a search manner while sequentially changing the values of controlled system model parameters so as to make the evaluation function value F approach an optimal value, the Powell method or the like, which is generally known, may be used.

The flow of processing performed by the controlled system model generating apparatus in FIG. 1 will be described next with reference to FIG. 2. First of all, the controlled system model parameter search computation unit 8 performs controlled system model parameter generation processing (step S1 in FIG. 2).

The simulation computation unit 5 then performs the simulation processing described with reference to FIG. 4 (step S2). The evaluation function computation unit 7 performs the above evaluation function processing (step S3).

After the simulation processing and the evaluation function processing are finished, the controlled system model parameter search computation unit 8 determines whether the processing in steps S1 to S3 with respect to all combinations of values which controlled system model parameter can take is terminated (step S4). If the processing in steps S1 to S3 with respect to all combinations of values which controlled system model parameters can take is terminated, the flow advances to step S5. Otherwise, the flow returns to step S1 to cause the controlled system model parameter search computation unit 8 to generate a new combination of the values of the process gain Kp, process dead time Lp, and process time constant T1. In this manner, the processing in steps S1 to S3 is executed with respect to each of the combinations of the values which the process gain Kp, process dead time Lp, and process time constant T1 can take, thereby obtaining the evaluation function values F corresponding to the respective combinations.

If the processing in steps S1 to S3 is terminated with respect to all the combinations of the values which the controlled system model parameters can take, the controlled system model parameter search computation unit 8 extracts a combination of the process gain Kp, process dead time Lp, and process time constant T1 which provides a minimum evaluation function value F_min by executing evaluation function value comparison processing (step S5). The extracted combination of the process gain Kp, process dead time Lp, and process time constant T1 is determined as a model parameter search result (step S6). With the above operation, the processing performed by the controlled system model generating apparatus is terminated.

In this embodiment, a control system model as a combination of a controller algorithm used by the user in an actual control system and a mathematical model of a controlled system is virtually generated on a computer, and the model controlled variable of the control system model is calculated when the set parameters for the controller actually used by the user are provided for the control system model. A simulation of simulating the control system model is repeated by using the evaluation function value representing the proximity between the time-series data of an actually observed real controlled variable and the time-series data of the model controlled variable such that the evaluation function value approaches an optimal value. In this manner, a search is made for one parameter or a numerical combination of a plurality of parameters in the mathematical model of the controlled system. This makes it unnecessary to acquire the time-series data of the manipulated variable MV, and it suffices to acquire only the time-series data of the real controlled variable PV. The user can automatically generate a mathematical model of a controlled system without having any advanced expert knowledge. Using this mathematical model makes it possible to adjust parameters for the controller by a simple method like that described in reference 1.

In this embodiment, as parameters concerning the controller, the proportional band Pb, integral time Ti, derivative time Td, set point SP, and control period cdt are presented. However, such parameters include an upper limit value MVH, lower limit value MVL, and change rate limit dMVlim concerning the manipulated variable in the actual controller. More preferably, these parameters are registered as needed.

In this embodiment, evaluation function value comparison processing (S5) is executed after search end determination (S4). However, numerical value model parameter determination processing (S6) may be performed at the same time as the end of search by storing, in advance, only a combination of parameters which can provide a minimum function value while sequentially executing controlled system model parameter generation processing (S1), simulation processing (S2), evaluation function processing (S3), and evaluation function value comparison processing (S5) with respect to each combination of controlled system model parameters.

The controlled system model generating apparatus described in this embodiment can be implemented by a computer comprising a CPU, storage device, and interface and programs for controlling these hardware resources. The CPU executes processing like that described in this embodiment in accordance with the programs stored in the storage device.

The present invention can be applied to automatic generation of a controlled system model in process control.

What is claimed is:

1. A controlled system model generating apparatus comprising:
a real controlled variable storage unit which stores time-series data of a real controlled variable as a control result on an actual controlled system;
a model storage unit which stores, in advance, a mathematical model of a controlled system having at least one parameter;
a controller storage unit which stores, in advance, a controller algorithm which virtually generates a controller;
a simulation computation unit which executes a simulation of simulating a control response concerning the control system comprising a controlled system represented by a mathematical model stored in said model storage unit and a controller represented by the controller algorithm stored in said controller storage unit;
an evaluation function computation unit which compares a real controlled variable stored in said real controlled variable storage unit with a model controlled variable which is a controlled variable calculated by a simulation executed by said simulation computation unit and computes an evaluation function value representing a proximity between the real controlled variable and the model controlled variable; and
a controlled system model parameter search computation unit which causes said simulation computation unit to execute a simulation while sequentially changing a value of a controlled system model parameter set for a mathematical model, and determines, as a model parameter search result, a value of a controlled system model parameter with which an evaluation function value computed by said evaluation function computation unit becomes an optimal value.

2. An apparatus according to claim 1, wherein said controller is a PID controller.

3. An apparatus according to claim 1, wherein said controlled system model parameter search computation unit comprises
a controlled system model parameter generating unit which generates a plurality of values which a controlled system model parameter can take,
an evaluation function value comparing unit which compares evaluation function values obtained with respect to the respective values generated by said controlled system model parameter generating unit and extracting a value of a controlled system model parameter which provides a minimum evaluation function value, and
a controlled system model parameter determining unit which determines a value extracted by said evaluation function value comparing unit as a model parameter search result.

4. A controlled system model generating method comprising:
the step of executing a simulation of simulating a control response concerning a control system comprising a controlled system represented by a mathematical model stored in advance and a controller represented by a controller algorithm stored in advance;
the step of comparing a real controlled variable as a control result on an actual controlled system and a model controlled variable as a controlled variable calculated by a simulation, and computing an evaluation function value representing a proximity between the real controlled variable and the model controlled variable; and
the step of executing a simulation while sequentially changing a value of a controlled system model parameter set for the mathematical model, an determining, as a model parameter search result, a value of a controlled system model parameter with which an evaluation function value becomes an optimal value.

5. A method according to claim 4, wherein the executing step comprises the step of executing a simulation concerning a control system comprising a PID controller as a controller and a mathematical model.

6. A method according to claim 4, wherein the step of determining comprises the steps of
generating a plurality of values which a controlled system model parameter can take,
comparing evaluation function values obtained with respect to the respective generated values, and extracting a value of a controlled system model parameter which provides a minimum evaluation function value, and
determining the extracted value as a model parameter search result.
